(19) United States
(12) Patent Application Publication
(10) Pub. No.: US 2004/0120705 A1
(43) Pub. Date: Jun. 24, 2004

(54) Differentiated resilience in optical networks

(76) Inventors: Robert Friskney, Harlow (GB); Song Dong, Egham (GB); Christopher Phillips, Hutton (GB)

Correspondence Address: William M. Lee, Jr., Lee, Mann, Smith, McWilliams, Sweeney & Ohlson, P.O. Box 2786, Chicago, IL, 60690-2786, US

(21) Appl. No.: 10/323,409

(22) Filed: Dec. 18, 2002

(51) Int. Cl. G02F 1/00

(52) U.S. Cl. 398/5; 398/1

(57) ABSTRACT

A transparent wavelength routed optical network has two or more different optical layer restoration schemes to provide different levels of resilience, and a restoration allocator arranged to allocate the optical layer restoration schemes, to different parts of the traffic. This can enable similar capacity for high resilience traffic as a single resilience level network, and provide additional capacity for lower resilience level traffic, which can reflect the value of the traffic. The allocator can be located centrally in a network manager, or in distributed fashion at each node, and can depend on a translation of a parameter requested by the customer. Nodes have message processors for receiving a message for reserving a path, determining if the path has become unavailable, and if so, sending a second message to collect information about any other paths still available on the same route.

### FIELD OF THE INVENTION

This invention relates to apparatus for optical networks for allocating one of a number of restoration schemes having different resilience, to apparatus for reserving network resources for restoration, to nodes for such networks, to methods of operating transparent wavelength routed optical networks, to methods of reserving network resources for restoration, to apparatus for optical networks for processing messages relating to reserving paths, and to methods of offering a transmission service over such apparatus.

### BACKGROUND TO THE INVENTION

Despite the recent downturn in the telecommunications industry, there is still a long term trend towards substantial optical network capacity growth, to accommodate the still rapid rise in data traffic brought on by new Internet and enterprise applications such as virtual private networks (VPNs) and e-commerce. At the same time, the introduction of optical networking with wavelength-division multiplexing (WDM) transmission technology, optical multiplexers and optical cross-connect (OXCs) devices, is moving towards the vision of creating an “all-optical” Internet. Configuring these devices enables establishment of all-optical connections, or lightpaths, between source and destination nodes. These all-optical lightpaths provide transparent data communication and eliminate the electronics costs and bottlenecks at intermediate nodes.

In a WDM network without wavelength conversion capability, a connection between two nodes must use the same wavelength on all links along the route. This requirement is referred to as the wavelength continuity constraint. Lightpath based WDM networks are generally referred to as wavelength-routed networks. If a common wavelength is not available on all links along the route, then the connection is blocked. Traditional optical networks have been designed and deployed in backbone networks as a service-independent layer to meet the demands of highly multiplexed and predictable voice and private-line traffic. In this context, the primary network requirement is high reliability. As a result, optical resilience is designed statically using offline algorithms and all traffic is treated identically and fully protected. However, the static network design and provisioning mechanism becomes more and more clumsy and inefficient to accommodate the drastic evolution of Internet infrastructure.

Firstly, static optical resilience provisioning assumes that the operator can forecast demand, to decide how to add capacity to the network in an optimal manner to support the demand. This prediction becomes more and more difficult to make because of the unprecedented growth of Internet data traffic. Thus, dynamic optical provisioning is becoming more and more important for the service provider to respond quickly and economically to customer demands.

Secondly, the Internet explosion has diminished the predominance of voice traffic and private-line traffic relative to the now exponential growth of data traffic, which has presented a wide range of resilience requirements. For example, traffic generated by free Internet access services requires a much lower grade of service than that of bank data transactions.

Dynamic provisioning for optical networks needs control and signalling protocols support. A consensus is emerging in the industry on utilising an IP-centric control plane within optical networks to support dynamic provisioning. This was driven by recent advances in the control plane technology for Multi-Protocol Label Switching (MPLS) traffic engineering, which can be adapted for use in optical networks by generalising the concept of a label in traditional MPLS. Generalised MPLS (GMPLS) provides a framework for dynamic provisioning of connections in optical networks and allows the use of uniform semantics for network management and operations control in hybrid networks. Existing routing and signalling protocols within the traditional MPLS are also extended to support GMPLS. In particular, the Internet Engineering Task Force (IETF) is focusing on the enhancements to the Open Shortest Path First (OSPF) routing protocol, and the Resource Reservation Protocol (RSVP) signalling protocol.

The problem of provisioning lightpaths by routing and assigning a wavelength to each connection is referred to as the routing and wavelength assignment (RWA) problem. For dynamic provisioning, when evaluating performance, connection requests can be modelled as two types, incremental and dynamic. In the incremental case, a connection request arrives and the lightpath is deployed sequentially and remains in the network indefinitely. In the case of dynamic traffic, connection is set up according to the request with a finite lifetime, called holding time. When the holding time expires, the connection is dropped.

Known optical resilience provisioning under the framework of dynamic provisioning will now be summarized. Currently, there are three types of resilient lightpaths being considered within the IETF, dedicated (1+1) protected lightpaths, shared protected lightpaths and unprotected lightpaths. The basic idea of dedicated protection in mesh optical networks derives from 1+1 APS (Automatic Protection System) in SONET/SDH. In dedicated protection, a back-up path is established for the protected primary path along a physically diverse route. Both paths are active and the failure along the primary path results in an immediate switchover to the backup path. In shared protection, for a primary lightpath, a physical diverse backup path is set up for the protection of the primary path. During the establishment of the backup lightpath, optical resources (channel, wavelength) are reserved while OXCs are not set. Thus the backup resources can be shared by other backup paths, which do not have a common possible failure component. This sharing condition ensures that all lightpaths with mesh-shared protection can be restored after any single failure. For unprotected lightpaths, no resource is reserved for the protection of primary path. A failure along the lightpath will result in traffic disruption.

Optical dynamic provisioning for wavelength routed optical networks (WRONs) has been studied in a number of research papers such as. C. Assi, et al., “Optical Networking and Real-time Provisioning: An Integrated Vision for the Next-Generation Internet”, IEEE Network, pp. 36-45, July/August 2001, S. Sengupta and R. Ramamurthy, “From Network Design to Dynamic Provisioning and Restoration in Optical Cross-Connect Mesh Networks: An Architectural and Algorithmic Overview”, IEEE Network, pp. 46-54, July/August 2001 and H. Zang, et al., “Dynamic Lightpath Establishment in Wavelength-Routed WDM Networks”, IEEE Communications Magazine, pp. 100-108, September 2001. These introduce the infrastructure of an IP-centric controlled optical network supporting the optical dynamic provisioning. Some basic routing algorithms (fixed routing, semi-adaptive routing and adaptive routing) are also introduced. Other research publications, R. A. Barry and P. A. Humblet, “Models of Blocking Probability in All-Optical Networks with and without Wavelength Changers”, IEEE Journal of Selected Area in Communications, Vol. 14, No. 5, pp. 858-867, 1996, and A. Birman, “Computing Approximate Blocking Probabilities for a Class of All-Optical Networks”, IEEE Journal of Selected Area in Communications, Vol. 14, No. 5, pp. 852-857, 1996 focus on the analytical modeling and experimental analysis of blocking probability under the dynamic provisioning of optical connections. However, all the performance analysis in such previous work assumed a single level of optical resilience provisioning.

### SUMMARY OF THE INVENTION

It is an object of the present invention to provide improved apparatus and methods. According to a first aspect of the present invention, there is provided apparatus for use in a transparent wavelength routed optical network having a number of working paths for traffic, and two or more different optical layer restoration schemes to provide different levels of resilience, the apparatus having: a restoration allocator arranged to allocate a different one of the optical layer restoration schemes, to different parts of the traffic, for use if their working path becomes unavailable.

A significance of having multiple restoration schemes is that demands for transmitting traffic with different levels of resilience can be handled with more efficient use of network resources, even in a transparent wavelength routed network. Such networks have the critical and unique constraint called the wavelength continuity constraint, which means that many conventional path allocation schemes are very inefficient. The inventors discovered that providing multiple levels of resilience in such networks can enable virtually the same capacity for high resilience traffic as a known single resilience level network, and provide a surprisingly high level of additional capacity for lower resilience level traffic.

“Resilience level” is defined as the likelihood of continued operation despite the failure of one or more components, optionally with a specified tolerable level of disruption during the process of recovery. This includes, for example, the ability to continue operating after a fiber-link is accidentally cut.

The restoration preferably involves moving the traffic onto an alternative path which is “fault diverse”, meaning that no single fault—of some specified variety—can cause two or more of the traffic routes to fail simultaneously. Examples of this are fibre diversity (no two paths may travel along the same fibre), duct diversity (no two paths may travel along the same duct) and geographical diversity (e.g. no two paths may pass through the same city). Restoration is sometimes used to mean a slower non-real-time process to establish a restoration path, and the term protection or protection switching used to mean faster, real time switching of traffic onto a pre determined path. In this document, restoration is intended to encompass both, and all variations.

The advantages can apply in principle whether the allocator is located centrally such as in a network manager, or in distributed fashion at each node, for example. Likewise, the advantages can apply whether the restoration is applied to an end to end path of the given part of the traffic, or applied over a link or a number of links in the path. In principle, different schemes could be applied to different parts of a single path if the risk of the working path being unavailable varies along the path. In principle the allocation and reservation can be for new traffic or be a reallocation and re-reservation of existing traffic. A more cost-effective mechanism is provided to provide different resilience that better reflects the value of the traffic being carried. It can apply to any configuration of network, including a ring, interconnected rings, partial meshes, or full meshes. Although primarily concerned with fully transparent WRONs, the advantages still apply to networks having some wavelength conversion capability at some nodes. In such networks, the wavelength continuity constraint will still apply to segments of paths before or after any wavelength conversion.

The allocation can be on the basis of a scheme requested by the customer, or a translation of a parameter such as resilience or restoration time requested by the customer, in a contract, or using a default if no request is made by the customer for example. The use of the different schemes can lead to cascading where traffic is moved to a restoration path and pre-empts other lower priority traffic, which is moved and pre-empts other even lower priority traffic, and so on. This is no problem if it leads to better overall use of resources and does not disrupt the traffic unduly, to a greater degree than is tolerable by that type of traffic.

An additional feature of some embodiments is the allocator being arranged to allocate a scheme to a working path carrying a given part of the traffic.

This is usually preferable to allocating to traffic regardless of its path, though in some cases, such as packet based traffic or inverse multiplexed traffic, it may be appropriate to allocate to traffic rather than path.

An additional feature of some embodiments is the apparatus being located in a node of the network where the given part of the traffic enters the network.

This is a convenient location for allocating the restoration scheme, and allows a distributed arrangement which can bring advantages of greater speed of operation compared to a centralized arrangement.

An additional feature of some embodiments is the restoration schemes including at least one of the following: a dedicated 1+1 scheme, a shared protection scheme, a non reserved non premptible scheme, and a non reserved pre-emptible scheme.

These are commonly used schemes and there are numerous variants of each that can be used as desired, to give finer grained differences to suit demand.

An additional feature of some embodiments is the restoration schemes differing in at least one of the following attributes: speed of restoration, numbers of faults tolerated, level of guarantee of restoration, amount of network resource used, fault diversity and availability level.

An additional feature of some embodiments is the allocator being arranged to receive a resilience parameter desired for a given part of the traffic and automatically select which restoration scheme to allocate to achieve the parameter.

This can enable customers to demand resilience parameters to suit their traffic without having to know details of the restoration schemes.

A second aspect of the invention provides apparatus for use in transparent wavelength routed optical network having

a number of working paths for traffic, and

two or more different optical layer restoration schemes to provide different levels of resilience, the apparatus having:

a restoration controller arranged to cause an allocated one of the restoration schemes to be carried out when the traffic fails on one of the working paths.

This has corresponding advantages to those set out above. It can be combined with the allocator.

An additional feature of some embodiments is the controller being arranged to reserve at least some of the network resources needed for implementing the allocated restoration schemes, the reservation being carried out in anticipation of a working path becoming unavailable.

This is typically needed for higher resilience types of restoration schemes, and can limit the capacity of the network.

An additional feature of some embodiments is the controller being arranged to configure the network to enable any of the allocated restoration schemes which do not require network resources to be reserved before any working path is lost, to be carried out once the working path is lost.

This is suitable for lower resilience types of restoration schemes, but often makes more efficient use of network capacity.

An additional feature of some embodiments is the apparatus being located in a node of the network where traffic can enter the network.

This is a convenient location for allocating the restoration scheme, and allows a distributed arrangement which can bring advantages of greater speed of operation compared to a centralized arrangement.

An additional feature of some embodiments is the restoration schemes including at least one of the following: a dedicated 1+1 scheme, a shared protection scheme, a non reserved non premptible scheme, and a non reserved pre-emptible scheme.

These are commonly used schemes and there are numerous variants of each that can be used as desired, to give finer grained differences to suit demand.

An additional feature of some embodiments is the restoration schemes differing in at least one of the following attributes: speed of restoration, numbers of faults tolerated, level of guarantee of restoration, amount of network resource used, fault diversity and availability level.

An additional feature of some embodiments is the controller being arranged to cause an end to end restoration path through the network to be found and then reserved.

This is often preferred over schemes which determine and reserve a restoration path one link at a time, for the sake of efficiency by avoiding too much reservation of resources which are not ultimately used, and for the sake of speed of operation.

An additional feature of some embodiments is the controller being arranged to calculate a restoration path from a network topology map stored locally.

An additional feature of some embodiments is the topology map having an indication of a current status of each link in terms of how the restoration schemes are currently using the link.

This can enable much more efficient use of links compared to known schemes in which only the predetermined restoration path allocation was available, without information about whether the restoration path was in use.

An additional feature of some embodiments is a message processor arranged to reserve the restoration path by sending a message to another node on the path to collect current information about which wavelengths are available, to enable a decision on which wavelength to reserve.

This is a preferred way of reserving the path which can enable better scaling than a typical centralized provisioning scheme.

An additional feature of some embodiments is the message processor being arranged to receive a message originated from another node, and reserve a wavelength, or if the desired wavelength has become unavailable, send a message to another node along the path to collect information about which wavelengths are still available along the route of the path.

This is useful in case some wavelengths along some links have become occupied since the topology map was last updated. It helps handle the wavelength continuity constraint. An additional feature of some embodiments is an optical switch for routing the wavelengths, and a switch controller for controlling the switch to set up the reserved restoration path to implement the restoration scheme.

This part enables the implementation and in principle need not be co-located with the restoration controller, but in practice it is convenient to have them co-located in the same node.

An additional feature of some embodiments is software for implementing the apparatus. This acknowledges that software can be a valuable, separately tradable commodity. It is intended to encompass software, which runs on or controls “dumb” or standard hardware, to carry out the desired functions, (and therefore the software essentially defines the functions of the apparatus, even before it is combined with its standard hardware). For similar reasons, it is also intended to encompass software which “describes” or defines the configuration of hardware, such as HDL (hardware description language) software, as is used for designing silicon chips, or for configuring universal programmable chips, to carry out desired functions.

A third aspect of the invention provides a node for a transparent wavelength routed optical network, the node having an optical switch, for routing wavelengths, and having the apparatus set out above.

A fourth aspect of the invention provides a node for a transparent wavelength routed optical network, the node having:

an optical switch for routing traffic, and

a controller arranged to receive an indication of which of a number of restoration schemes having different resilience levels, is allocated to a given part of the traffic, and to control the optical switch to implement a restoration of the given part of the traffic according to the corresponding scheme, upon receiving a trigger indication.

This aspect is included to cover components which do not include a reservation function, or which cooperate with a reservation function located elsewhere, to achieve corresponding advantages.

A fifth aspect provides a corresponding method, or a method of operating a transparent wavelength routed optical network having a number of working paths for traffic, the method having the steps of:

allocating one of a number of different optical layer restoration schemes to provide different levels of resilience for restoring the traffic in the event of one of the working paths becoming unavailable.

This aspect specifies operating a network in case it proves more valuable than the apparatus, or if corresponding advantages are obtained without all the apparatus for example.

An additional feature of some embodiments are the steps of:

allocating different restoration schemes having different resilience levels, to different parts of the traffic, for use if a working path is unavailable, and

reserving at least some of the network resources needed for implementing the allocated restoration schemes.

This is included to cover the activity in case it proves more valuable than the apparatus. A sixth aspect of the invention provides apparatus for a node of an optical network arranged to set up an end to end path taking a chosen route through the network for traffic, the apparatus having:

a message processor arranged to receive a message originated from another node along the path, the message relating to reserving the path, the part being arranged to determine if the path has become unavailable, and if so, to send a second message to another node along the route to collect information about any other paths that are still available on the same route.

This is useful in case any part of the path (which can be a wavelength or time slot or any other “multiplexable” parameter) along any link in the route have become occupied since the path was initially selected. It is particularly useful in highly dynamic networks, or in larger networks, for which it is harder to keep track of the free wavelengths, when selecting a path. It can help handle the wavelength continuity constraint. In principle it can be used for working paths or for restoration paths. The messages can be sent to either end of the path. They can be used for reserving the wavelength, or for setting up the path immediately. The message can be part of a protocol involving passing messages up and down the path (e.g. a “two pass” scenario). It can apply not only to transparent WRONs, but also to any type of optical network.

An additional feature of some embodiments is the information including a count of the available wavelengths.

This is a basic and simple indicator of whether it is worth trying the same route again. An additional feature of some embodiments is the information including an identity of the available wavelengths.

This is better than a mere count of the number of available wavelengths because an updated picture of wavelength availability can be gathered, for use in the decision of whether to try another wavelength on the same path.

An additional feature of some embodiments is receiving and passing on a preliminary message for gathering information on wavelength availability along the path, for use in determining the wavelength to be requested.

This is a “two pass” scenario and enables a better decision on which wavelength to request, than a “one pass” scenario, particularly where there is no up to date global wavelength usage database. Typically topology maps exclude wavelength usage information as it multiplies the amount of information needed per fiber, and because wavelength usage changes rapidly and so is harder to keep up to date.

An additional feature of some embodiments is the apparatus being arranged to determine the routing of the next hop in the path, upon receiving the preliminary message.

This hop by hop routing is an alternative to predetermined routing. This enables routing to be based on more up to date locally held information, but risks not attaining a globally optimum route.

A seventh aspect provides a method of offering a data transmission service over the network. The advantages of the invention can enable improvements to be made in the network performance such as being more reliable or more flexible, having a greater capacity, or being more cost effective. Consequently data transmission services over the network can be enhanced, and the value of such services can increase. Such increased value over the life of the system, could prove far greater than the sales value of the equipment.

Any of the additional features can be combined with any of the aspects of the invention as would be apparent to those skilled in the art. Other advantages will be apparent to those skilled in the art.

### BRIEF DESCRIPTION OF THE DRAWINGS

To show by way of example how the invention can be implemented, embodiments will now be described with reference to the figures in which:

FIG. 1 shows an optical network having a partial mesh configuration with multiple different restoration schemes in use, according to an embodiment of the invention,

FIG. 2 shows a node for a network having the apparatus according to an embodiment,

FIG. 3 shows a centralized network management system having the apparatus according to an embodiment,

FIG. 4 shows a route selection procedure flowchart according to another embodiment,

FIG. 5 shows a sequence chart of different restoration processes according to an embodiment,

FIG. 6A shows a part of a network,

FIG. 6B shows a sequence chart for the part of FIG. 6A showing how failure of a reservation is handled according to an embodiment,

FIG. 7 shows a link status state machine, for use in embodiments, and

FIG. 8 shows a graph of increased network capacity in an example network having multiple different restoration schemes.

### DETAILED DESCRIPTION OF PREFERRED EMBODIMENTS

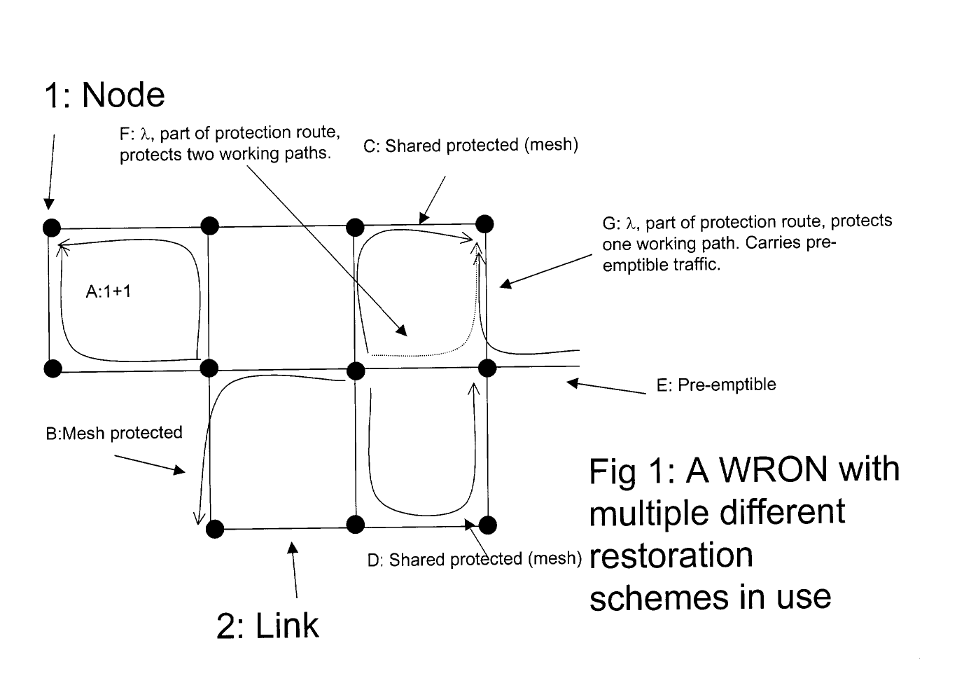

FIG. 1 shows an example of a wavelength routed optical network (WRON) having multiple nodes and links arranged in a partial mesh (meaning there is not a link from every node to every other node). The network is shown supporting multiple “interworking” restoration mechanisms according to an embodiment of the invention. A WRON node typically consists of some form of transparent optical switching element (e.g. MEMS mirror arrays, patch panels), where transparent means that the signal is not electronically terminated and re-originated. Alternately or additionally, nodes that may originate/terminate traffic will have appropriate optical transmission/receiving equipment. Links will carry multiple wavelengths. The combination allows a wavelength to originate at one node and be routed to its destination through multiple switching elements, without being electronically regenerated and without the requirement to be take the same route as all other wavelengths originated at the same node.

The curved lines denote provisioned traffic, specifically:

A: The working and dedicated protection wavelengths of a 1+1 protected service.

B: A mesh-protected working connection—note that there is no protection connection pre-established.

C: A shared-protection working connection. If this path fails, traffic will be routed along F and G.

D: A shared-protection working connection. If this path fails, traffic will be routed along F. Note in particular that D is not a shortest path—this route has been chosen to maximise protection route sharing and thus minimise total network resources consumed.

E: A pre-emptible connection segment that has exclusive use of this link. This traffic is switched into the wavelength-segment G.

F: A wavelength-segment pre-reserved for the shared protection of C and D. Note that C and D are link diverse, so no single fault could require that both need restoration simultaneously.

G: A wavelength-segment pre-reserved for the shared protection of C. As C is currently operating properly, it is actually carrying pre-emptible traffic, continuing the path from E. If C failed, its traffic would be re-routed via F and G and the path from E would be broken.

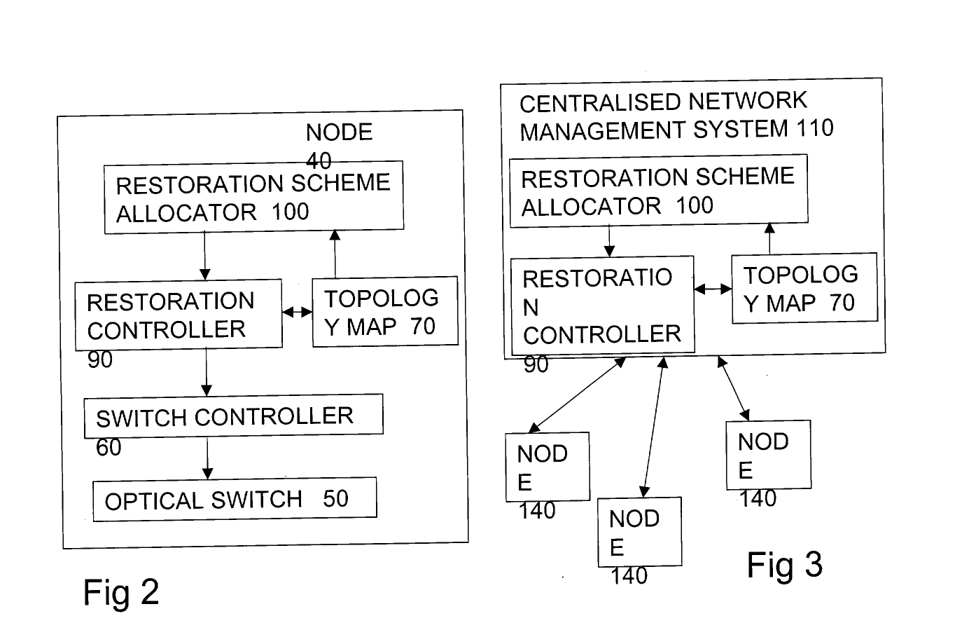

FIGS. 2 and 3 show examples of embodiments of the apparatus for use in the network of FIG. 1 or in other networks. In FIG. 2, an example of a node 40 for a decentralized arrangement is shown. The node can be anywhere in the network. It is suitable for adding traffic to the network, not just switching traffic already in the network. A restoration scheme allocator 100 allocates a type of restoration scheme to a part of the traffic, typically new traffic about to be admitted. The choice is fed to a restoration controller 90, which causes the scheme to be implemented. This may involve reserving network resources, such as restoration paths, or by flagging that a working path has no reserved restoration path, and that the restoration path must be determined or set up when it needs to be used, perhaps with a given level of priority to enable it to pre-empt some other traffic. A topology map 70 is optionally provided to keep track of the working and reserved paths and the restoration scheme allocated to each path. It may be updated from other nodes as well as this node.

The restoration controller can be coupled to a switch controller 60 to set up restoration paths when needed, by controlling an optical switch 50. The optical switch typically routes each wavelength (not shown) individually or in bands to set up paths along a desired link to the next node.

In FIG. 3, an example of a centralized arrangement of the apparatus is shown. In this case, the restoration scheme allocator, the restoration controller and the topology map are held centrally rather than in each node. They are parts of a network management system 110, coupled to remote nodes 140 having optical switches to set up paths as before. In another example, not illustrated, the restoration controllers are distributed in the nodes as in FIG. 2, for speed of operation, but the allocator can be arranged centrally, to have better access to a central global topology map.

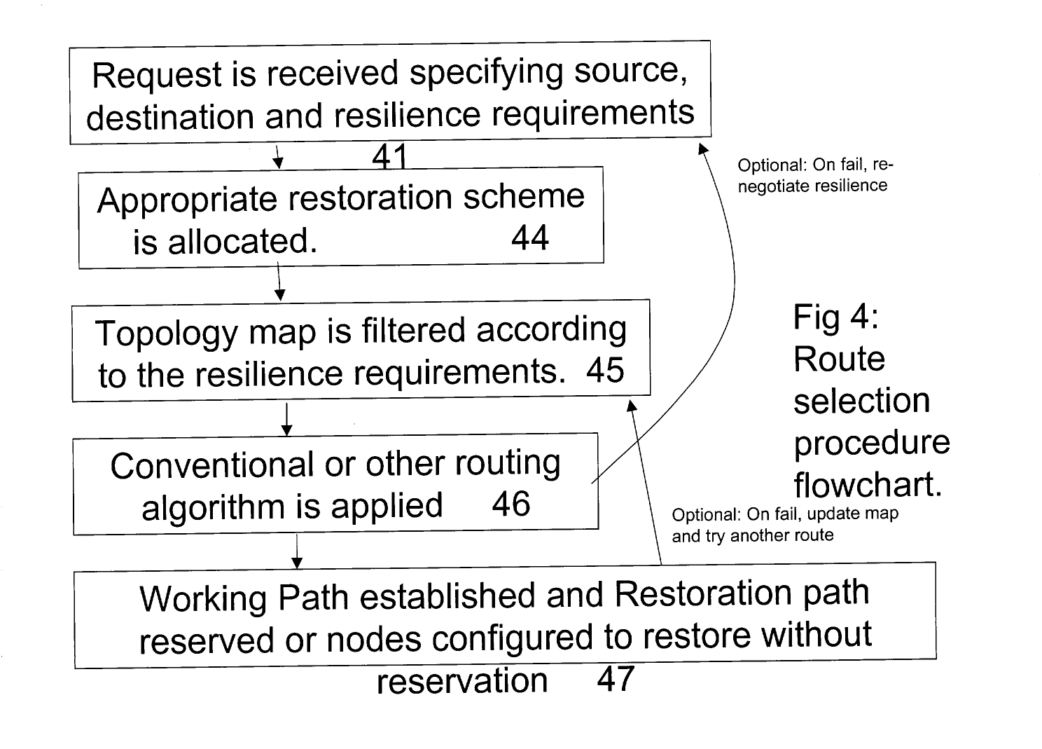

FIG. 4 shows an example of the process of establishing a new working path with a restoration scheme, for use in the nodes or networks of FIGS. 1-3, or in other nodes or networks. At step 41, a connection request is received from a customer of the network operator (by phone, electronically or otherwise for example). This request consists of the source and destination nodes and any resiliency requirements. Resiliency requirements may be expressed in many ways: Customers may demand a particular resilience mechanism or, more sensibly, demand a particular level of resilience (knowing this affects the price charged)—e.g. <5 minutes/year, <20s/incident—and/or may demand fault-diversity relative to some other links or entities—e.g. new connection must not go through the same fiber as my existing connections or maybe new connection must not go within 300km of old connection (to satisfy Federal Reserve banking resilience rulings to give geographical resilience for example).

Translation of resilience requirements into an appropriate restoration scheme will now be discussed. In some cases, the customer may specify the resilience scheme that they require directly. It is a more helpful service to ask the customer what resilience attributes they require and for the operator to allocate resources to provide this. Some example resilience attributes (which somewhat overlap) are:

Speed of restoration.

Fault tolerance—e.g. 1+1 can only tolerate one failure which may not be acceptable over large distances.

Guarantee of restoration—>90% after one failure, 100% after one failure, 100% after two failures, for example.

Availability—usually expressed as time/period. Often expressed in several ways, e.g. 99.999%/year AND no more than 1 minute/day

Resource hungriness—usually only the carrier cares about this one!

Fault diversity, for various types of faults.

Price—obviously important.

Examples of the translation arrangement (although this is dependent upon operator policy) are:

Example A) Requirement “Path from A->Z with 99.9999% availability that avoids city X”: The system observes using the topology map that it can find routes from A to Z (avoiding X) of approx 3000 km. Fault occurrence on the network is retrieved from a database as 10 faults/fibre/1000 km/year. Therefore, predicted fault rate on a path of this distance is 30 faults/year. Time to repair for a fault is retrieved from a database as 2 hours (to simplify this illustration, this is assumed to have a standard deviation of 0). Therefore, the expected incidence of simultaneous independent faults (it is expected that one fault can't cause both to fail) on two parallel routes is approximately 17 seconds/year, which is rather less than the committed 31 seconds/year—at least, when averaged over a long enough period. Therefore a standard 1+1 scheme provides more than enough resilience. However, a shared protection scheme sharing protection with another working path of similar link has an expected outage of 34 seconds/year, which is too much. Therefore a 1+1 protection provides (barely) adequate protection. [In reality, a prudent operator might require a resilience margin, or that the availability figure was met over a single year and therefore require a higher availability scheme, e.g. multiple split protection domains with matched-node interconnections (the mesh equivalent of serial rings) or 1+1+1—however we will ignore that possibility for this example.] Therefore, the operator would provision the shortest pair of the A-Z (excluding X) paths found and provision them as a 1+1 pair.

Example B) Requirement: “3 paths from A->Z with a combined availability of 99.9999%, lowest cost.” Calculations proceed in a similar fashion, except it is found that 3 paths from A->Z have a completely excessive availability compared to the requirement, even when completely unprotected, but that 3 pre-emptible paths gives too low an availability. Therefore, offer a route-diverse set of 2 unprotected and one pre-emptible path.

As can be seen from the above examples, this is a multi-dimensional choice process—not a simple basic, better, best type of choice. The above examples are expressed as serial conditional statements for ease of understanding. In practice, a decision tree technique/specification method can be used.

At step 44, the resilience level required is translated into an appropriate resilience scheme. At step 45, the network topology map (also called graph) is filtered according to the resilience requirements. Different resilience schemes look at the network in different ways to find a preferred path, using criteria such as: can somebody else's protection capacity be reused? Can other traffic be pre-empted? Can particularly high-cost links be used? Can new capacity deployment be justified? Depending on the answers, the topology graph is filtered differently and different paths appear available.

To take the specific running example used in FIG. 1:

1+1 traffic ‘sees’ a graph consisting of all wholly unused wavelengths and all wavelengths used only by pre-emptible traffic.

Shared protection sees the same graph.

Mesh-protected links see the same graph. [Although a potentially desirable policy option may be to make it see only wholly unused links]

Pre-emptible traffic sees all wholly unused wavelengths, plus all shared protection capacity not currently actually carrying traffic.

At this point it may also be desirable to filter out any links that will not satisfy the fault diversity policy requested. If fault diversity requirements are more complex then they may need to be implemented as a modification to the routing algorithm.

At step 46, an appropriate conventional routing algorithm can then be executed on this filtered graph. If no appropriate working and restoration path can be found, this information is sent to the customer (or user's agent) who may wish to try a different resilience requirement, or otherwise rethink their request.

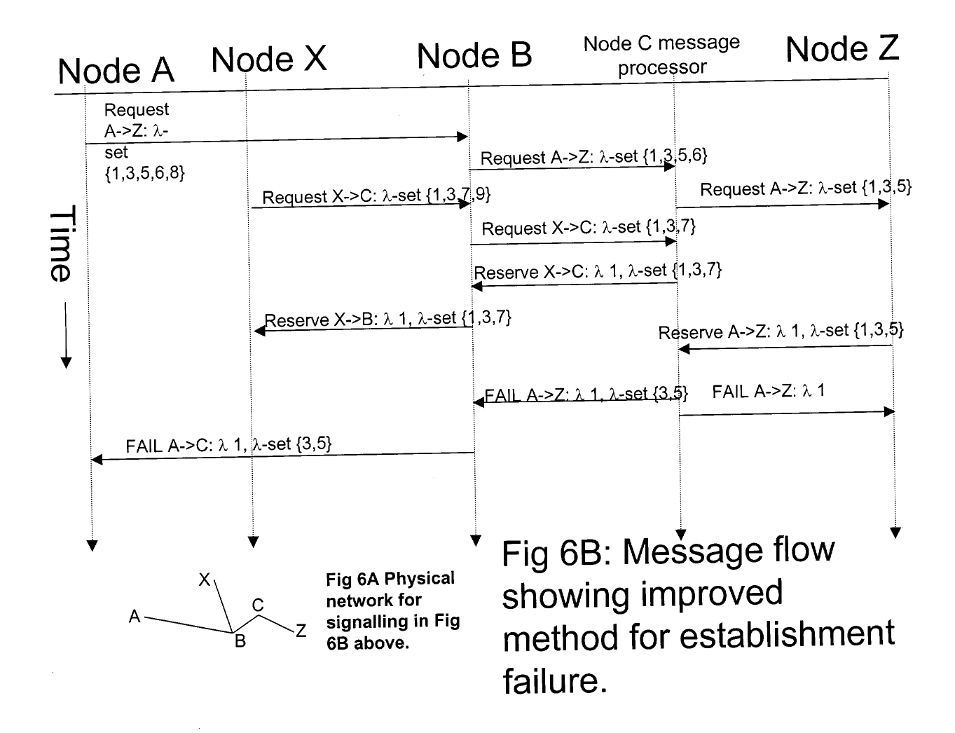

At step 47, the working path is established and restoration path reserved or flagged as not being reserved. As discussed later with reference to FIGS. 6A and 6B, this step may fail due to resources becoming unexpectedly unavailable, or otherwise. In this case, a new route may be calculated upon the updated topology.

Optical Restoration options will now be discussed. Provisioning a GMPLS backup LSP connection consists of three actions: path calculation, resource reservation and cross connect. Path calculation involves the calculation of the link-disjoint/node-disjoint path. Resource reservation involves the reservation of wavelength channel for the backup LSP. Cross connect includes selection of the reserved resource and setting up the connection. The optical restoration options can be classified into four categories depending on whether these three actions for the backup path are performed before or after a failure event as illustrated in Table 1.

For category 1, a separate connection is set up and set aside for restoration. In the event of a failure, restoration simply involves the cross-connect action at both ends of the connection, which makes this option the fastest and be able to achieve the restoration time benchmark (50 ms), set by SONET. However, this option is also the most expensive since all the resource (time/space channel, wavelength) is allocated and the cross-connects are set before the failure, which can not be shared by other traffic. This option is generally referred to as 1+1 Dedicated protection.

For category 2, the backup paths are calculated and resources reserved before a failure event arises so it guarantees successful traffic restoration. Additionally, because the cross-connects are set after the failure, the backup resource can be shared by other traffic prior to the failure event. However, signalling from

TABLE I
OPTICAL RESTORATION OPTIONS

| | | Resource | | |
|---|---|---|---|---|
| Category | Path Calculation | Reservation | Cross Connect | Feasible |
| 1 | Before | Before | Before | Yes |
| 2 | Before | Before | After | Yes |
| 3 | Before | After | After | No |
| 4 | After | After | After | Yes |

Path Switch LSR (PSL) is needed to notify the interim optical cross connects (OXCs) to select the reserved channel and build up the backup connection. Some constraints such as signalling propagation delay, cross-connect time and the large number of optical connections that need to be set up in response to a single failure make its restoration time hard to achieve the goal of 50 ms. Experimental results show that this option is able to restore traffic within several hundreds ms.

TABLE II
SERVICE CLASSIFICATION AND RESILIENCE STRATEGIES

| Service Class | RC1 | RC2 | RC3 | RC4 |
|---|---|---|---|---|
| Resilience | High | Medium | Low | Best Effort |
| Requirement | | | | |
| Restoration | <50 ms | <500 ms | <2 s | <60 s |
| Time | | | | |
| Resilience | Category 1 | Category 2 | Category 4 | Category 4 |
| Strategy | | | | |

For category 3, a backup path is pre-calculated and saved in the PSL. When there is a failure, the PSL sets up the backup path using either the CR-LDP or RSVP-TE signalling protocol. Since the resources are not reserved at the time of the original path calculation and they may be consumed later by other traffic, this option cannot ensure a successful restoration in a dynamically changing network, which makes this option impractical. This option only saves time by pre-calculating the path that would be requested if a failure were to arise. This could be trivial in a next generation OXC with high processing performance.

For category 4, all the three actions are performed after failure. Although this option, referred to as fully dynamic restoration is the most cost efficient, it needs a longer restoration time. This is caused by the inaccurate link state information for path calculation immediately after the failure and the large number of connections to be restored at the same time, in which case link contention often occurs. The restoration time taken by this option is favourably comparable to that of a distributed network restoration scheme since it uses link state information to calculate the alternative path, instead of flooding messages to search for one as in the distributed scheme. 2 seconds restoration time is typically achievable for category 4.

An example of a set of optical service resilience classes having different resilience requirements will now be described, with reference to Table II.

Optical services of Resilience Class 1 (RC1) have the highest resilience requirements and require traffic restoration within 50 ms.

Optical services of Resilience Class 2 (RC2) have medium resilience requirements of being restored within 500 ms.

Optical services of Resilience Class 3 (RC3) have relatively low resilience requirements with restoration times less than 2s and no guarantee of restoratioin.

Optical services of Resilience Class 4 (RC4) are best-effort traffic and can be pre-empted by services of all other resilience classes. However, if there is spare resource, they could be restored after failure in around 60s.

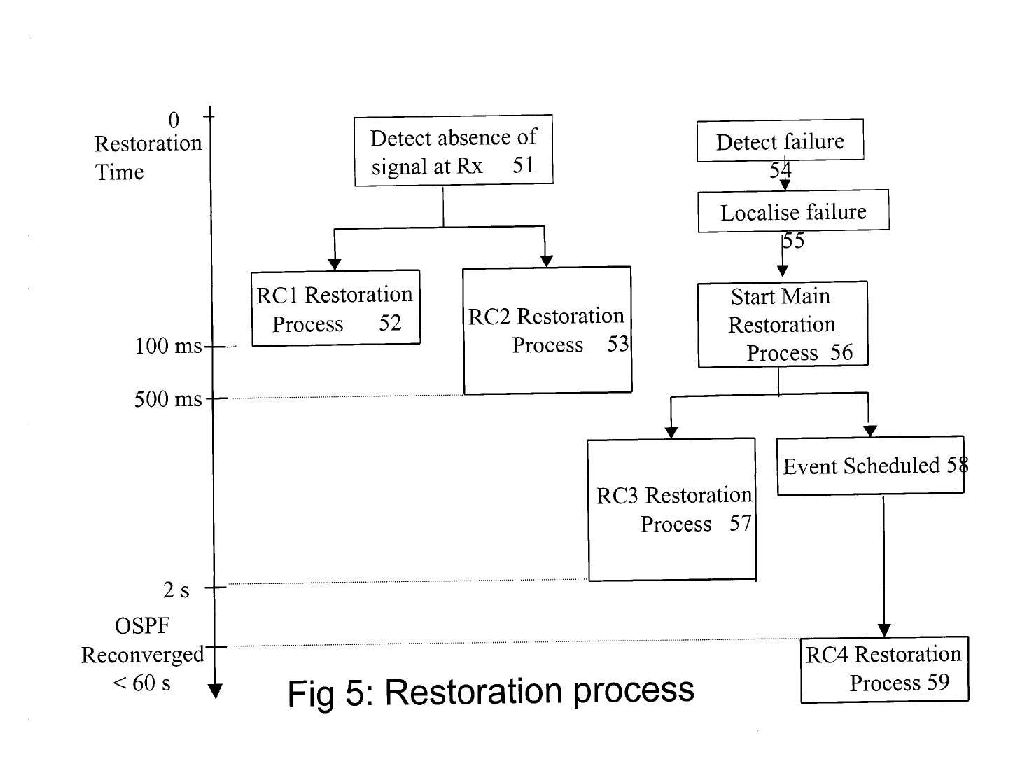

FIG. 5 shows a timeline for four different restoration processes RC1 RC2, RC3 and RC4, as described above. The primary application of this is where a link (or network equipment) fails, but the right-hand side of it is also used when pre-emptible traffic has been pre-empted. To explain: When a link failure occurs:

1+1 (RC1): The receiver detects a loss of valid signal on the working path at step 51 and switches to receiving from the protection path, shown by step 52.

Shared protection (mesh) (RC2): The receiver detects a loss of valid signal on the working path and signals the head-end to establish the protection path at step 53—kicking off any pre-emptible traffic currently using it.

Mesh restoration (RC3): Failure is detected at step 54, and localised to the affected segment at step 55. Mesh restoration at steps 56, 57 seeks to route around this segment.

Pre-emptible (RC4): As with mesh restoration though instead of the RC3 mesh restoration process, the RC4 process is delayed to allow mesh restoration to be completed. This involves an event scheduling step 58 before the restoration process 59. Note that the former two methods do not need to localise the failure, which saves a lot of time.

FIGS. 6A and 6B show an example of an improved method for dealing with wavelength provisioning failure. FIG. 6 A shows part of a network having nodes A B C and Z in a line, with a branch from B to another node X. The operation of sending messages to reserve and set up a wavelength is shown in FIG. 6B. There is a conflict at Node C in this example, hence node C is shown in more detail and has a message processor, typically implemented in software, optionally as a component of the switch controller shown in FIG. 2, since only local information is needed. Such a message processor is incorporated in all nodes. The scenario shown in FIG. 6B is a two pass example, as follows:

A signals to B a preliminary message to gather wavelength availability for a connection to Z. In this example the route for the path has been predetermined at node A, rather than determining the route by a centralized network manager, or locally hop by hop. The message is propagated via C to Z, with each node updating the wavelength set by a set intersection of the set given in the message with the wavelength set available on their link to the next node. Node Z chooses one of these and sends back a message requesting that wavelength be used. However, in the meantime, another path (from X to C) has ‘grabbed’ part of the route on the wavelength chosen by Z. A failure message is returned to node Z by the message processor of node C, such that it can free the partially-provisioned chosen wavelength.

Conventionally, the sending part of node C would return a failure message to the first node and it might assume that that route was unusable and try another—presumably less desirable e.g. more costly—route, or even report failure to the requesting user. However, actually a second call attempt would be likely to succeed. Therefore (as pictured in FIG. 6B) in the reservation message the identity of the available wavelengths is returned (to propagate back in the same way as it came), to give the originating node the information it needs to determine whether it should retry the connection. It may simply immediately retry if there are any wavelengths free, or may have a policy to only retry when, say, there are more than 3 wavelengths free—where the call rate is high and there is a high probability that some of those will be ‘stolen’ during a second attempt. This modification should both increase available network utilisation (by decreasing resource usage) and decrease blocking probability (by not giving up on the optimum connection until there really are no resources available).

A simpler version requiring less processing for intermediate nodes would be for the destination node to simply return a count of free wavelengths—the size of the final label set—decremented by 1 by the blocking node. This would have the disadvantage that it would not capture the high-call-rate case where several wavelengths had been ‘stolen’ while the first call tried to be established, but greatly reduces the worst-case message-sizes and processing times.

Note that this problem of failed establishment arises in wavelength continuous networks, except networks having no wavelength continuity constraint such as those with complete electronic regeneration at every node. In such networks the path can take a different wavelength at any node to avoid blocking. The problem and solution also apply where there is another type of continuity constraint such as where the incoming and outgoing ‘label’ must be identical, such as TDM networks with no time-slot interchange capability/freedom. An example of the latter would be a system running a 4-fibre protection scheme, which requires connections to stay on the same time-slot all the way across the ring to maintain protection switching speeds—even if intermediate nodes would be capable of such interchange if not running 4-fibre protection.

Integration of Differentiated-Resilience with Optical Services will now be described. Link Status is used in conventional routing schemes. The link state routing protocol OSPF has been extended within the IETF to flood optical network information within an optical domain. In OSPF, these optical router and link attributes are flooded as opaque Link State Advertisements (LSAs). These attributes are put in a hierarchical Type/Length/Value (TLV) triplet. Among the link attributes, there is a sub-TLV (Link Protection Type) dealing with network resiliency. The Link Protection Type represents the protection capability that exists for a link. Six protection capabilities are defined so far: Extra Traffic, Unprotected, Shared, Dedicated 1:1, Dedicated 1+1 and Enhanced.

The definition of Link Protection Type is intended to provide information that may be used by path calculation algorithms to set up LSPs with the appropriate protection characteristics. However, this mechanism assumes that the resilience algorithm has already determined the protection type(s) of all the underlying links. The path calculation algorithm has no idea of how the resilience schemes have utilized the underlying resources and have no direct control over them. All that is available to the path calculation mechanism is information concerning the pre-calculated resilience state of each link. This lack of awareness between the path calculation algorithm and the resilience enactment activity results in inefficient resource allocation.

If the resilience assignment of each link has been pre-established by the resilience algorithm such that there is one Unprotected, one Extra Traffic and one Dedicated 1:1 link for example, the path calculation mechanism can only select between these options even though it may have preferred an alternative assignment (i.e. three Unprotected links). To make better use of the available underlying resource, the resilience assignment should be dynamic, with the service requirements dictating how the links are configured, performing the resilience assignment and path calculation together, according to current service requirements.

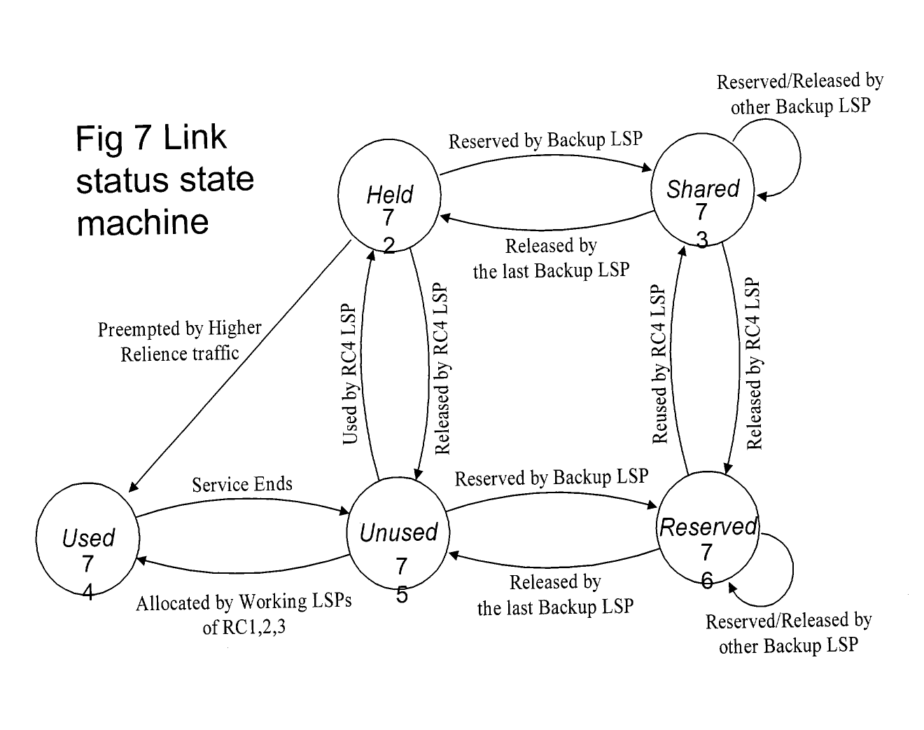

In order to realise this mechanism, a optical link attribute, called Link Status is used. The Link Status attribute includes five types: Unused, (75) Used, (74) Reserved, (76) Shared (73) and Held (72). FIG. 7 shows an example of a state machine indicating how the status can change. Unused links are not used by any traffic nor reserved by backup LSPs. Used links are those through which un-preemptable working LSPs are running. They cannot be shared with any other traffic. When the optical service is finished, Used links are released and the status transferred to Unused. Reserved links are those used by backup LSPs. Additional parameters show which link or node failures they are protecting against. Reserved links for one backup LSP can be shared with other backup paths that have node/link disjointed working paths, or used by preemptable traffic. In the former case, the link status remains as Reserved and the additional parameters are refreshed with new link and node failures being added to the link state database. While in the latter case, the status becomes Shared. Shared links are Reserved links used by preemptable traffic. They cannot be shared by other active traffic, but the additional parameters are maintained. Once the preemptable service is terminated, the status becomes Reserved. Finally, Held links are those being used by preemptable traffic (RC4).

In a distributed routing mechanism, the detailed Link Status information is maintained in the local database of each OXC. Only the aggregated Link Status information is broadcast and available for path calculation in the ingress OXC.

Resilience Strategies will now be described. Traffic is generally protected or restored using end-to-end (path) restoration within an individual optical domain. Path restoration has the advantage of being more resource-efficient than link restoration. However, in a large optical domain, the time taken by path restoration for a long end-to-end optical path may be unable to satisfy the requirements of services with high resilience (RC1). In this case, the long optical path can be segmented into several pieces, with backup LSPs deployed for each piece. This strategy is not needed for services with a low resilience requirement (Resilience Class 2, 3 and 4) since the extra time taken by end-to-end restoration is a relatively small part in the total restoration time.

For RC1 traffic, optical resilience category 1 is used. For RC1 services, the working LSP can use links whose status is Unused or Held when resources are limited (RC4 services will be pre-empted in this case). Backup LSPs can use Unused or Held links.

For RC2 traffic, optical resilience category 2 is used. The pre-calculated and allocated backup LSPs ensure the traffic can be restored. Since the cross-connects are set only after failure, the backup LSPs can be reused in pieces. At the time of LSP path calculation and deployment, the working LSP uses Unused links, or Held links if resource is limited (RC4 services will be pre-empted). Then, the status of these links becomes Used. The backup LSP can use Unused links, or Reserved links, or Held links, or Shared links. Accordingly, these links become Reserved, Reserved, Shared and Shared, respectively.

For RC3 traffic, optical resilience category 4 is used, as category 3 is impractical. The node-disjoint/link-disjoint restoration LSPs are calculated and deployed only after a failure. RC3 services cannot be pre-empted. So, at the time of the alternative LSP provisioning in response to a failure, only those links with a status of Unused or Held (if resource is limited) can be used.

For RC4 traffic, optical resilience category 4 is used. The restoration of RC4 services starts at the time when OSPF has re-converged (within 60 s). At this time, each node has accurate information of the revised network states after the failure. Also, the links previously used by the failed services of type RC1 , RC2 and RC3 , having been reclaimed, will provide more resource for restoration. Unlike RC3, the restoration LSP of RC4 services can use Unused and Reserved links. However, the restoration of RC4 could fail due to there being no spare resource.

Both RC3 and RC4 are unprotected services and could experience unsuccessful restoration if resources are limited. However, there is still the necessity to distinguish these two classes. RC3 cannot be pre-empted and can preempt RC4. Their restoration times are also different.

The resilience provisioning algorithm is typically performed at the ingress OXC, which serves as the PSL. Different resilience strategies are provided for the different optical services. For RC1 and RC2 services, a pair of link-disjoint/node-disjoint working and backup paths are calculated according to the aggregated link information. Sharing of any link on the backup path is determined during signalling of the proposed backup path. Information about the working path is also carried in the signalling message. When it receives the signalling message, each OXC on the backup path decides whether the proposed backup path can reuse the resource already reserved by other backup paths. The decision is based on the detailed Link Status information, which is maintained in OXC's local database. For RC3 and RC4 services, only the working path is calculated and deployed.

Almost all the restoration processes as shown in FIG. 5 are originated and performed in the PSL. The Path Merge LSR (PML) performs active actions only in RC1 restoration. When the PSL is notified of the failure, it starts the main restoration process. The main restoration process retrieves information about the failed services and produces three child processes, immediately (i.e. the RC1, RC2 and RC3 restoration processes). It also schedules the RC4 restoration process for subsequent action once reconvergence has taken place, as shown in FIG. 5.

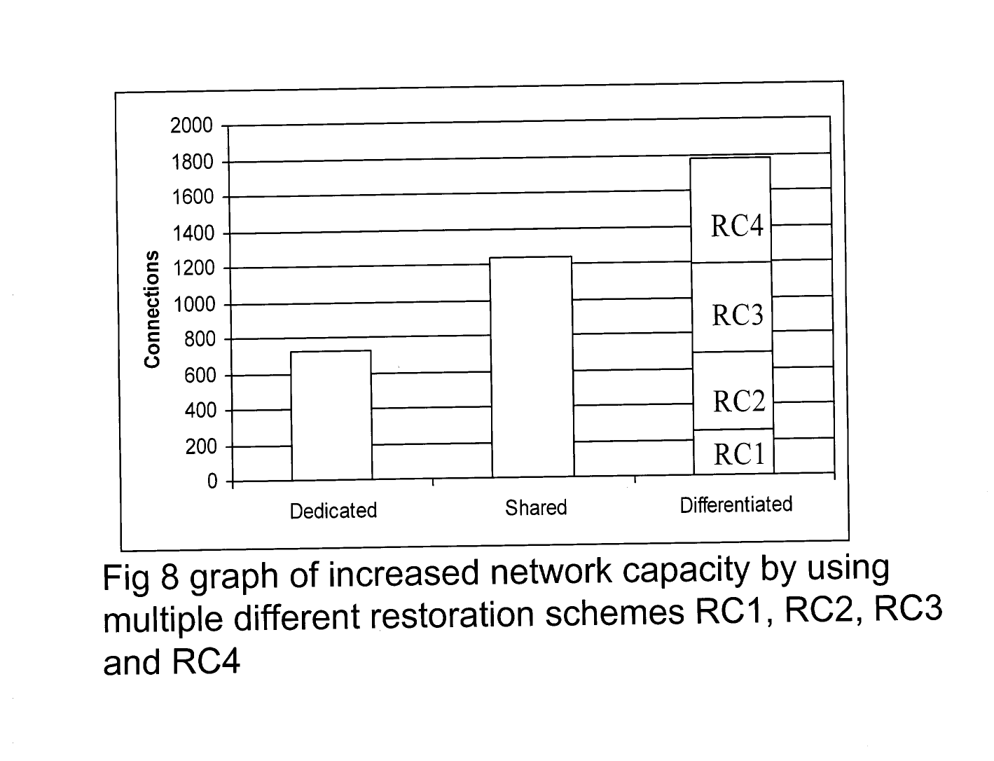

FIG. 8 shows a graph of increased network capacity in an example network having multiple different restoration schemes. These figures were obtained from simulations using the current Toronto metropolitan network which has 25 nodes and 55 links. It was assumed that each link in the network has 40 wavelengths and each wavelength channel has a default cost of 1 unit. The Poisson distribution is used for lightpath request inter-arrival times. Uniform load was assumed, that is, the average number of lightpaths is the same between every two nodes in the network. For comparison, simulations of single level resilience provisioning schemes, dedicated protection and shared protection were also carried out.

To investigate the capacity performance of the network under different schemes of resilience strategies, incremental traffic is used. In the incremental traffic scenario, connection requests arrive sequentially, a lightpath is established for each connection, and the lightpath remains in the network indefinitely.

The graph shows that the capacity in dedicated protection scenario, was only 727 connections deployed in the network. In shared protection scenario, there are 1237 connections being set up in the network. In the Differentiated Resilience scenario, totally the network accommodates in total 1778 connections, of which 251 RC1 connections, 439 RC2 connections, 504 RC3 and 584 RC4 connections. This shows more connections can be established in the network, with approximately the same amount of premium guaranteed traffic, if differentiated-resilience is supported.

Differentiated Resilience has another advantage that the network resource can be more efficiently used. In the scenario of dedicated protection, duo to the wavelength continuity constraint and dedicated protection requirement, only 87.6% resource can be used. There is about 12.4% of the network resource that cannot be used by any further connections. In the scenario of shared protection, 97% of the network resource is used either by primary paths or by backup paths. For the differentiated-resilience scenario, all the network resource is used due to the flexibility of the differentiated resilience provisioning.

### Concluding Remarks

As described above, a transparent wavelength routed optical network has two or more different optical layer restoration schemes to provide different levels of resilience, and a restoration allocator arranged to allocate the optical layer restoration schemes, to different parts of the traffic. This can enable similar capacity for high resilience traffic as a single resilience level network, and provide additional capacity for lower resilience level traffic, which can reflect the value of the traffic. The allocator can be located centrally in a network manager, or in distributed fashion at each node, and can depend on a translation of a parameter requested by the customer. Nodes have message processors for receiving a message for reserving a path, determining if the path has become unavailable, and if so, sending a second message to collect information about any other paths still available on the same route.

Other variations will be apparent to those skilled in the art, having corresponding advantages to those set out above, within the scope of the claims.

1. Apparatus for use in a transparent wavelength routed optical network having a number of working paths for traffic, and
two or more different optical layer restoration schemes to provide different levels of resilience, the apparatus having:
a restoration allocator arranged to allocate a different one of the optical layer restoration schemes, to different parts of the traffic, for use if their working path becomes unavailable.

2. The apparatus of claim 1, the allocator being arranged to allocate a scheme to a working path carrying a given part of the traffic.

3. The apparatus of claim 1, the apparatus being located in a node of the network where the given part of the traffic enters the network.

4. The apparatus of claim 1, the restoration schemes including at least one of the following: a dedicated 1+1 scheme, a shared protection scheme, a non reserved non premptible scheme, and a non reserved pre-emptible scheme.

5. The apparatus of claim 1, the restoration schemes differing in at least one of the following attributes: speed of restoration, numbers of faults tolerated, level of guarantee of restoration, amount of network resource used, fault diversity and availability level.

6. The apparatus of claim 1, the allocator being arranged to receive a resilience parameter desired for a given part of the traffic and automatically select which restoration scheme to allocate to achieve the parameter.

7. Apparatus for use in transparent wavelength routed optical network having a number of working paths for traffic, and
two or more different optical layer restoration schemes to provide different levels of resilience, the apparatus having:
a restoration controller arranged to cause an allocated one of the restoration schemes to be carried out when the traffic fails on one of the working paths.

8. The apparatus of claim 7, the controller being arranged to reserve at least some of the network resources needed for implementing the allocated restoration schemes, the reservation being carried out in anticipation of a working path becoming unavailable.

9. The apparatus of claim 7, the controller being arranged to configure the network to enable any of the allocated restoration schemes which do not require network resources to be reserved before any working path is lost, to be carried out once the working path is lost.

10. The apparatus of claim 7, the apparatus being located in a node of the network where traffic can enter the network.

11. The apparatus of claim 7, the restoration schemes including at least one of the following: a dedicated 1+1 scheme, a shared protection scheme, a non reserved non premptible scheme, and a non reserved pre-emptible scheme.

12. The apparatus of claim 7, the restoration schemes differing in at least one of the following attributes: speed of restoration, numbers of faults tolerated, level of guarantee of restoration, amount of network resource used, fault diversity and availability level.

13. The apparatus of claim 7, the controller being arranged to cause an end to end restoration path through the network to be found and then reserved.

14. The apparatus of claim 13, the controller being arranged to calculate a restoration path from a network topology map stored locally.

15. The apparatus of claim 14, the topology map having an indication of a current status of each link in terms of how the restoration schemes are currently using the link.

16. The apparatus of claim 13, having a message processor arranged to reserve the restoration path by sending a message to another node on the path to collect current information about which wavelengths are available, to enable a decision on which wavelength to reserve.

17. The apparatus of claim 16, the message processor being arranged to receive a message originated from another node, and reserve a wavelength, or if the desired wavelength has become unavailable, send a message to another node along the path to collect information about which wavelengths are still available along the route of the path.

18. The apparatus of claim 7, further having an optical switch for routing the wavelengths, and a switch controller for controlling the switch to set up the reserved restoration path to implement the restoration scheme.

19. Software for implementing the apparatus of claim 1.

20. A node for a transparent wavelength routed optical network, the node having an optical switch, for routing wavelengths, and having the apparatus of claim 7.

21. A node for a transparent wavelength routed optical network, the node having:
an optical switch for routing traffic, and
a controller arranged to receive an indication of which of a number of restoration schemes having different resilience levels, is allocated to a given part of the traffic, and
to control the optical switch to implement a restoration of the given part of the traffic according to the corresponding scheme, upon receiving a trigger indication.

22. A method of operating a transparent wavelength routed optical network having a number of working paths for traffic, the method having the steps of:
allocating one of a number of different optical layer restoration schemes to provide different levels of resilience for restoring the traffic in the event of one of the working paths becoming unavailable.

23. The method of claim 22, having the steps of:
allocating different restoration schemes having different resilience levels, to different parts of the traffic, for use if a working path is unavailable, and
reserving at least some of the network resources needed for implementing the allocated restoration schemes.

24. Apparatus for a node of an optical network arranged to set up an end to end path taking a chosen route through the network for traffic, the apparatus having:
a message processor arranged to receive a message originated from another node along the path, the message relating to reserving the path, the part being arranged to determine if the path has become unavailable, and if so, to send a second message to another node along the route to collect information about any other paths that are still available on the same route.

25. The apparatus of claim 24, the information including a count of the available wavelengths.

26. The apparatus of claim 24, the information including an identity of the available wavelengths.

27. The apparatus of claim 24, arranged to receive and pass on a preliminary message for gathering information on wavelength availability along the path, for use in determining the wavelength to be requested.

28. The apparatus of claim 24, arranged to determine the routing of the next hop in the path, upon receiving the preliminary message.

29. A method of offering a data transmission service over a network having the apparatus of claim 1.
